(19) United States
(12) Patent Application Publication
(10) Pub. No.: US 2009/0129796 A1
(43) Pub. Date: May 21, 2009

(54) IMAGE FORMING APPARATUS

(75) Inventor: Norikazu Ochiai, Izu-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/269,655

(22) Filed: Nov. 12, 2008

Related U.S. Application Data
(60) Provisional application No. 60/988,358, filed on Nov. 15, 2007.

(51) Int. Cl. G03G 15/08

(52) U.S. Cl. 399/43

(57) ABSTRACT

There are provided a control unit which controls image quality maintenance, a detection unit which detects a print command of image data, a calculation unit which calculates a print ratio of the image data when the print command for printing at least a predetermined number of sheets is detected, and a toner specific concentration control unit which sets toner specific concentration for each print of the plural sheets on the basis of the print ratio calculated by the calculation unit.

### CROSS-REFERENCE TO RELATED APPLICATION

This application claims the benefit of U.S. Provisional Application No. 60/988,358, filed Nov. 15, 2007.

### TECHNICAL FIELD

The present invention relates to a technique capable of maintaining an image quality in an image forming apparatus.

### BACKGROUND

Recently, a demand for a high quality image was increased with wide use of a color image forming apparatus. An electrographic type color image forming apparatus generally expresses a full color image by superimposing four color toners of Y (yellow), M (magenta), C (cyan), and K (black). Therefore, the colors of a final image are considerably changed even when each gray scale of four color toners slightly deviates. That is, it is important to uniformly maintain characteristics of the gray scale even when time is elapsed or an environment varies in use of the image forming apparatus. Accordingly, in the image forming apparatus, the image quality is controlled in various manners in order to maintain the characteristics of the gray scale.

JP-A-7-319236 discloses a method of reading the image concentration of a patch formed in an intermediate transfer belt by an optical sensor, adjusting toner specific concentration of a development unit, and allowing the image concentration to be normally uniform. In this image forming apparatus, the image concentration is controlled after print of one job.

However, in an environment where various users wait to use the image forming apparatus, a period of time for controlling image quality maintenance is required in order to restart the print when one user uses the image forming apparatus and then the next user wants to use the image forming apparatus. In addition, when an interval of the control of the image quality maintenance is too long, the image concentration varies during the control of the image quality maintenance.

Here, when the image forming apparatus prints an equal image on several hundreds of sheets or several thousands of sheets, the period of time for controlling the image quality maintenance is necessary. Therefore, the image quality maintenance is controlled whenever 1000 sheets are printed, for example. However, there occurs a problem in that a color may be changed since the image concentration before the control of the image quality maintenance and the image concentration immediately before the next control of the image quality maintenance are different from each other.

In view of such a circumstance, there is provided the image forming apparatus capable of reducing a change in the image concentration.

### SUMMARY

According to one aspect of the present invention, there is provided an image forming apparatus including: a control unit which controls image quality maintenance; a detection unit which detects a print command of image data; a calculation unit which calculates a print ratio of the image data when the print command for printing at least a predetermined number of sheets is detected; and a toner specific concentration control unit which sets toner specific concentration for each print of the plural sheets on the basis of the print ratio calculated by the calculation unit.

### DESCRIPTION OF THE DRAWINGS

FIG. 1 is a schematic view illustrating the appearance of an image forming apparatus to which a toner cartridge is applied according to embodiments.

FIG. 2 is a schematic view illustrating an inner configuration of the image forming apparatus when viewed from a front side according to the embodiments.

FIG. 3 is a block diagram illustrating a control system of the image forming apparatus according to the embodiments.

FIG. 4 is a schematic view illustrating the configuration of a development device according to the embodiments.

FIG. 5 is a diagram illustrating a first toner specific concentration variation table according to a first embodiment.

FIG. 6 is a diagram illustrating a second toner specific concentration variation table according to a second embodiment.

FIG. 7 is a diagram illustrating an example in which the toner specific concentration of each color is obtained according to the second embodiment.

### DETAILED DESCRIPTION

Hereinafter, embodiments will be described.

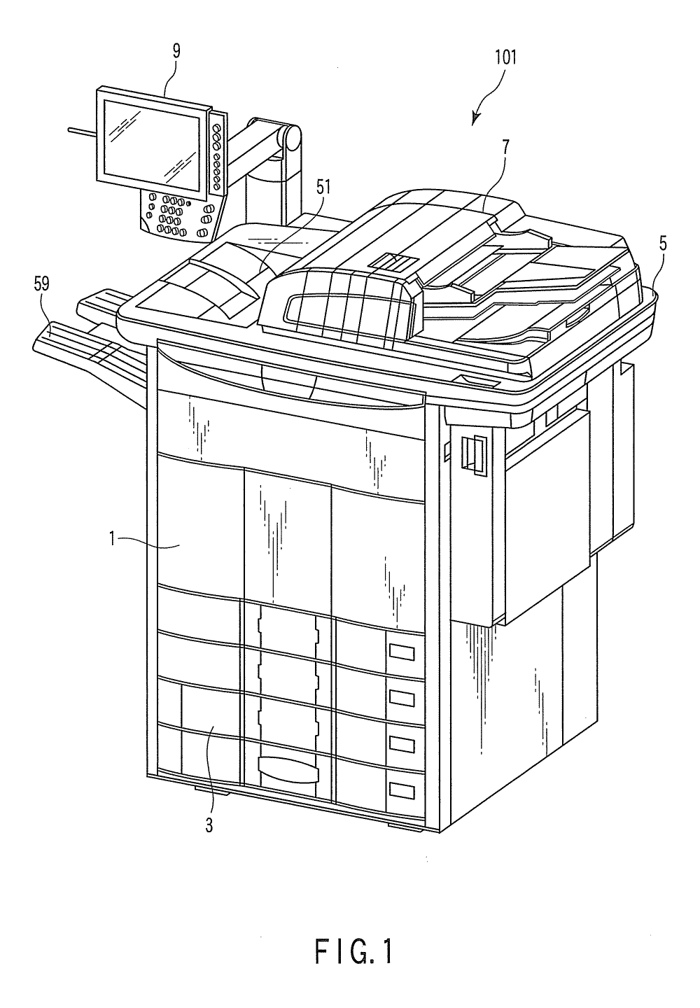

FIG. 1 is a perspective view illustrating the appearance of an image forming apparatus 101 according to embodiments. The image forming apparatus 101 is a four-tandem system color copier. The image forming apparatus 101 includes an image forming unit 1 which outputs image information as a print image called a hard copy or a printout, for example, a sheet supply unit 3 which supplies the image forming unit 1 with sheets (print mediums) having an arbitrary size and is used to print images, and scanner (image reading unit) 5 which acquires the image information, which is a target to be formed as an image in the image forming unit 1, as image data from an object (hereinafter, referred to as a document) holding the image information. Above the image forming unit 1, there is provided an automatic document feeding unit 7 which discharges a document subjected to scanning from a scanning location to a discharge location and guides the next document to the scanning location after the image reading unit 5 scans the image information in a sheet-shaped document. In addition, an input unit which instructs the image forming unit 1 to start image formation or the image reading unit 5 to start image scan, that is, a display unit 9 as a control panel is provided in the image forming apparatus 101.

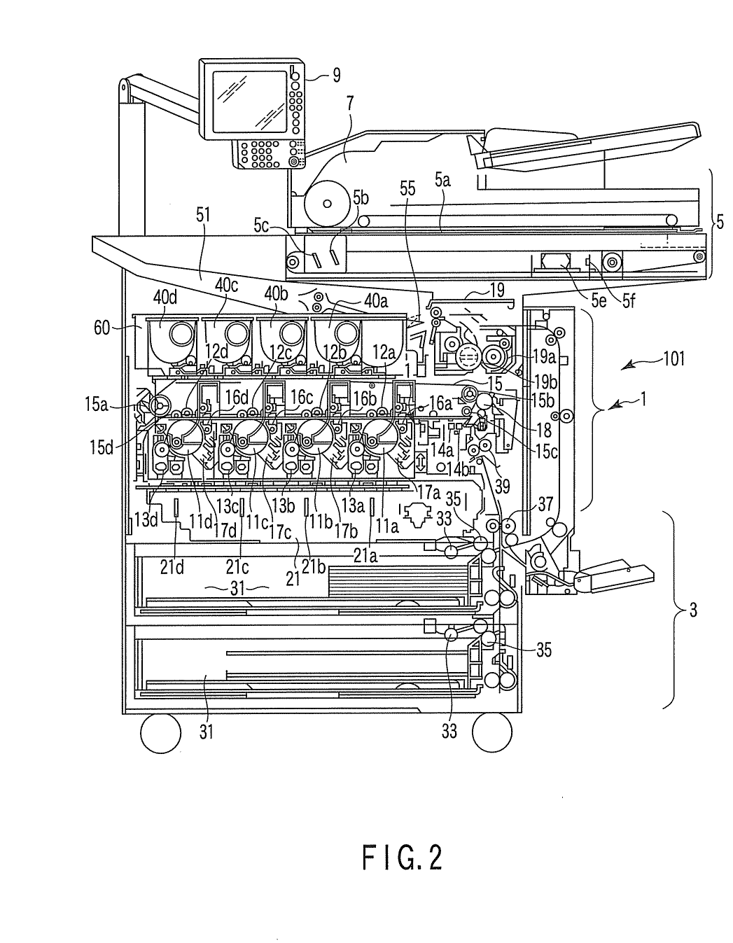

FIG. 2 is a schematic view illustrating the inner configuration of the image forming apparatus 101 when viewed from a front side. First, the configuration of the image reading unit 5 will be described. The image reading unit 5 includes a transparent platen glass 5a on which a document is placed, a light source 5b which irradiate the document, and a reflection mirror 5c which reflects light reflected from the document. The light source 5b and the reflection mirror 5c are integrally formed in a document irradiation unit 5d which is movable in a horizontal direction. Light reflected from the document irradiation unit 5d is received through a CCD 5f by an imaging lens 5e disposed in a light passage.

Next, the configuration of the image forming unit 1 will be described. Toner cartridges 40a, 40b, 40c, and 40d are arranged in parallel in an upper portion of the image forming unit 1. The toner cartridges 40a, 40b, 40c, and 40d are detachably mounted to a cartridge holding mechanism 60 which is provided on a front surface of the image forming unit 1. The toner cartridges 40a, 40b, 40c, and 40d supply yellow toner, magenta toner, cyan toner, and black toner, respectively.

The image forming unit 1 includes first to fourth photoconductive drums 11a to 11d which are image supporting members holding a latent image; development members 13a to 13d which develop the latent image formed in the photoconductive drums 11a to 11d; an intermediate transfer belt 15 which holds an image formed by laminating developers developed on the photoconductive drums 11a to 11d; cleaner 16a to 16d which remove respective toner remaining in the photoconductive drums 11a to 11d from the photoconductive drums 11a to 11d; and charging members 17a to 17d which uniformly charge the photoconductive drums 11a to 11d.

The image forming unit 1 further includes a transfer member 18 which transfers the image formed by laminating the developers on the intermediate transfer belt 15 onto a print medium such as a normal sheet which is not subjected to a special process or an OHP sheet as a transparent resin sheet; and a fixing member 19 which fixes the image of the developers transferred to a transferring medium onto the print medium. In addition, the image forming unit 1 further includes an exposure member 21 which includes LDs 21a to 21d emitting a laser beam modulated in accordance with the image data to be input to the photoconductive drums 11a to 11d and forming the latent image.

The intermediate transfer belt 15 is suspended by a driving roll 15a which rotatably moves the intermediate transfer belt 15, a tension roll 15b which allows tension applied to the intermediate transfer belt 15 to be uniform, and a backup roll 15c for secondary transferring.

In a position (primary transfer position) where the intermediate transfer belt 15 comes in contact with the photoconductive drums 11a to 11d, first transfer rolls 12a to 12d are arranged to come in press contact with the photoconductive drums 11a to 11d, respectively, through the intermediate transfer belt 15 in the rear surface of the intermediate transfer belt 15.

The transfer member 18 is disposed (secondary transfer position) to come in contact with the intermediate transfer belt 15 toward a toner supporting surface (outside) of the intermediate transfer belt 15 and is disposed in a rear surface (inside) of the intermediate transfer belt 15 to be opposed to the backup roll 15c. In addition, the backup roll 15c includes a counter electrode opposite the transfer member 18.

In a position where the driving roll 15a is provided in the intermediate transfer belt 15, a belt cleaner 15d is disposed to come in contact with the intermediate transfer belt 15 at a location opposite to the driving roll 15a with the intermediate transfer belt 15 therebetween.

An LED light source 14a and a light sensor 14b which detect amount of reflected light of a toner patch pattern formed in the intermediate transfer belt 15 are disposed between a fourth station of the primary transfer position and the secondary transfer position.

The first to fourth photoconductive drums 11a to 11d hold an electrostatic image (latent image) to be visualized (developed) by the development members 13a to 13d supporting respective toner of Y (yellow), M (magenta), C (cyan), and K (black) colors, respectively. The respective toner is arranged in a predetermined order in accordance with an image forming process or characteristics of the respective toner (developers). The intermediate transfer belt 15 holds developer images of the respective colors formed by the first to fourth photoconductive drums 11a to 11d and the development members 13a to 13d in an order of forming the developer images.

The sheet supply unit 3 supplies the print medium to the transfer member 18 at predetermined timing when the transfer member 18 transfers the developer images.

Cassettes loaded in a plurality of cassettes slots 31 receive print mediums having arbitrary sizes. A pickup roller 33 separates the print mediums in accordance with an image forming operation. The sizes of the print mediums correspond to the sizes of the developer images to be formed by the image forming unit 1. A separating mechanism 35 prevents two or more print mediums separated by the pickup roller 33 from being picked up out of the cassette. A plurality of transport rollers 37 transport only one print medium coming from the separating mechanism 35 toward an aligning roll 39. The aligning roll 39 sends the print medium to a transfer location where the transfer member 18 is in contact with the intermediate transfer belt 15 at timing at which the transfer member 18 transfers the developer image from the intermediate transfer belt 15. In addition, the plurality of cassette slots 31, the pickup roller 33, and the separating mechanism 35 are prepared, if necessary. The cassettes can arbitrarily be loaded to the different cassette slots.

The print medium onto which the image information is fixed by the fixing member 19 is discharged to a discharge tray 51 defined as a side of the image reading unit 5 and an upper portion of the image forming unit 1. Here, the fixing member 19 includes a fixing roller 19a and a pressurizing roller 19d on a downstream side in a sheet discharge direction. As for the print medium onto which the developer image is transferred, the image information is fixed by melting the developer image by the fixing roller 19a and the pressurizing roller 19d of which a temperature is increased up to 180° C.

The image forming apparatus 101 further includes a side sheet-discharge tray 59 on a side surface of the image forming unit 1. The print medium discharged from the fixing member 19 is guided to the side sheet-discharge tray 59 through a relay transport member 71 connected to a switching member 55.

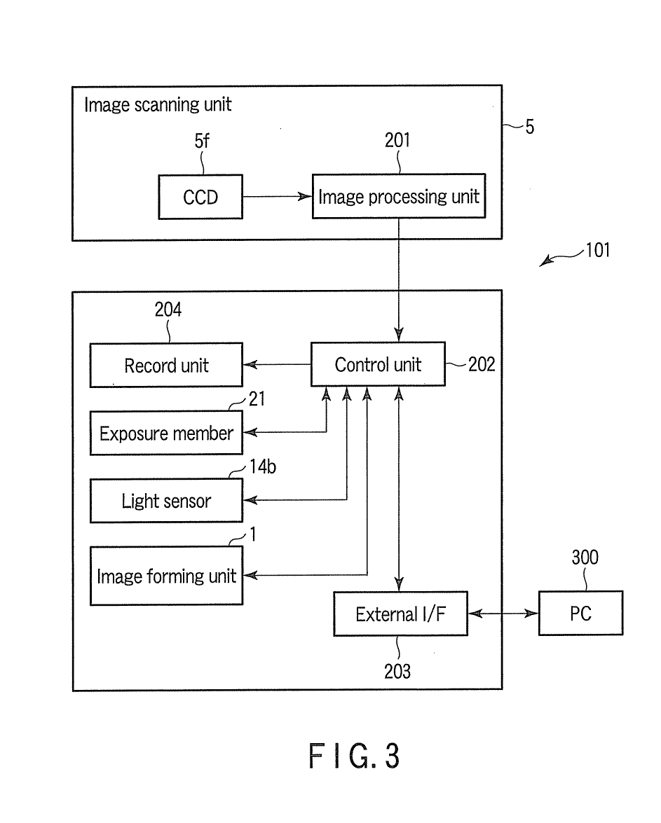

FIG. 3 is a block diagram illustrating a control system of the image forming apparatus 101 according to the embodiments. An image processing unit 201 is provided in the image reading unit 5. The image processing unit 201 converts a signal output from the reflected light received by the CCD 5f into the image data of yellow (Y), magenta (M), cyan (C), and black (K) colors, and performs data processing such as concentration correction on the image data to be output as inputting image data.

The image forming unit 1 includes a control unit 202, an external interface 203, and a record unit 204. The control unit 202 controls the LDs 21a to 21d of the exposure member 21 which emits a laser beam modulated in accordance with the image data input from the image processing unit 201 to the photoconductive drums 11a to 11d. The external interface 203 is connected to an external PC 300 to transmit and receive the image data. The record unit 204 records various types of information.

Now, the image quality maintenance will be described. The control unit 202 forms a beta patch or a high concentration patch recorded in the record unit 204 on the intermediate transfer belt 15 after controlling the image quality maintenance and printing 1000 or more sheets in total to control the image quality maintenance by adjusting the beta concentration.

The control unit 202 supplies the beta patch pattern to the exposure member 21. In addition, the exposure member 21 forms a latent image having the beta patch pattern in the photoconductive drums 11a to 11d. The development members 13a to 13d develop the latent image. Then, a development image is formed on the surfaces of the photoconductive drums 11a to 11d. The development image is transferred onto the intermediate transfer belt 15.

Subsequently, the control unit 202 allows the light sensor 14b to detect a reflection ratio of the beta patch pattern transferred onto the intermediate transfer belt 15, and then converts the reflection ratio into patch concentration. The control unit 202 detects a difference between the patch concentration and preset target concentration and changes an image formation condition from the difference to set the patch concentration so as to be equal to the target concentration.

The control unit 202 changes the image formation condition for the target concentration by changing a development bias value applied between the development members 13a to 13d and the photoconductive drums 11a to 11d, changing a charging potential for charging the photoconductive drums 11a to 11d by the charging members 17a to 17d while maintaining an equal potential difference, and changing a development contrast potential to adjust the patch concentration. In addition, the control unit 202 controls the image quality maintenance by changing the intensity of a laser beam and adjusting the patch concentration for the photoconductive drums 11a to 11d in the LDs 21a to 21d of the exposure member 21 capable of emitting the laser beam.

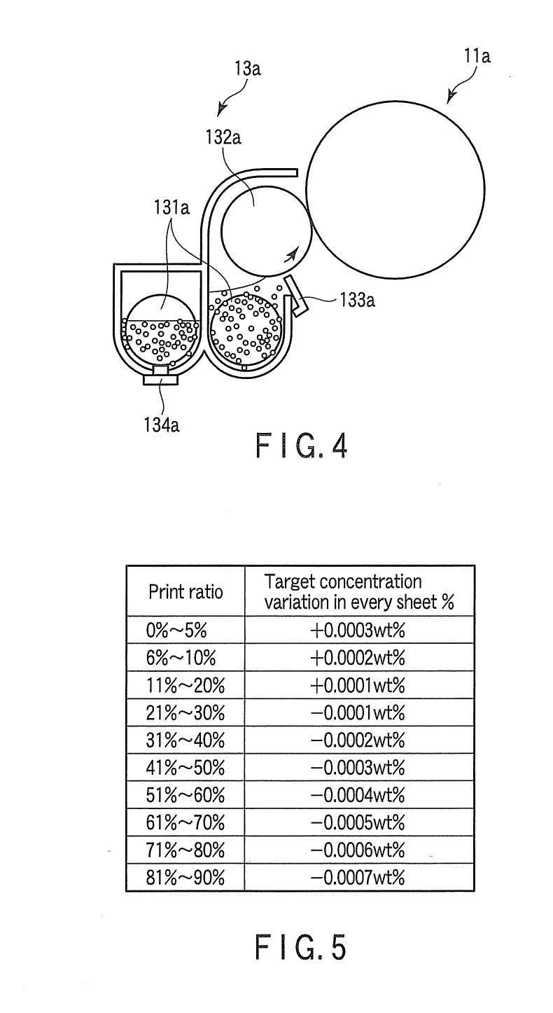

Next, the configuration of the development members 13a to 13d described above in FIG. 2 will be described with reference to FIG. 4. Here, the configuration of the development member 13a will be described. The same is also applied to the development members 13b to 13d. The development member 13a includes a mixer 131a, an Mg roller 132a, a doctor blade 133a, and a toner concentration sensor 134a. The mixer 131a mixes toner in the development member 13a. The development roller 132a transmits an electrostatic image formed by the toner to the photoconductive drum 11a. The doctor blade 133a allows an amount of toner loaded onto the development roller 132a to be uniform. The toner concentration sensor 134a detects a concentration ratio between the toner in the development member 13a and carrier. The toner concentration sensor 134a measures toner specific concentration from a current value for the toner in the development member 13a.

Here, when an interval of the image quality maintenance for the image forming unit 1 controlled by the control unit 202 is 1000 print sheets, the image concentration of a first sheet immediately after the control of the image quality maintenance is different from the image concentration of a 1000th sheet.

Next, a case where an equal image is printed on 1000 sheets without the change in the toner specific concentration will be described according to the embodiments. A high print ratio and a low print ratio calculated by the control unit 202 will be each described. The print ratio refers to a ratio occupied by pixels of image data when one sheet of a document is printed.

In the low print ratio, the image concentration of a 1000th printed sheet is lower than the image concentration of a first printed sheet. In the low print ratio, an amount of replaced toner in the development member 13a is small. Therefore, an amount of degraded toner remaining in the development member 13a increases. That is because the development member 13a lacks in the toner upon transporting the toner to the photoconductive drum 11a.

In the high print ratio, the image concentration of the 1000th printed sheet is higher than the image concentration of the first printed sheet. That is because in the high print ratio, a lot of low charged toner is transported to the photoconductive drum 11a since the development member 13a allows the toner to be transported to the photoconductive drum 11a before completing charge of the toner in the development member 13a.

That is, the image concentration varies in accordance with a print ratio and the number of print sheets, even when the toner specific concentration in the development member 13a is uniform after the control of the image quality maintenance. Accordingly, the control unit 202 needs to maintain the image concentration to permit printing regardless of the print ratio and the number of print sheets.

In the low print ratio, the control unit 202 needs to increase the toner specific concentration in accordance with the number of print sheets. As a result, the toner in the development member 13a is transported in a state where the toner is easily developed to the photoconductive drum 11a. In addition, in the high print ratio, the control unit 202 needs to decrease the toner specific concentration in accordance with the number of print sheets. As a result, the toner in the development member 13a is transported in a state where the toner is little developed to the photoconductive drum 11a.

That is, the difference of the image concentration can be complemented in such a manner that the control unit 202 changes the toner specific concentration in the development member 13a. The control unit 202 controls the toner specific concentration in the development member 13a so as to approach the target value and maintain the image concentration, as described below.

Next, change in the toner specific concentration will be described according to a first embodiment.

First, the control unit 202 controls the image quality maintenance for the image forming unit 1, when the control unit 202 detects the image data to be printed and the number of print sheets input through the display unit 9 by a user. Subsequently, the control unit 202 sets a predetermined initial value of the image concentration by changing a development bias value for the photoconductive drum 11a, a charging potential, and the intensity of a laser beam emitted from the exposure member 21. The control unit 202 stops the control of the image quality maintenance until the number of input print sheets are all printed or until print of the predetermined number of sheets (for example, 1000 sheets) ends.

Subsequently, the control unit 202 records in the record unit 204 the toner specific concentration in the development member 13a when the initial value of the image concentration is set. At this time, the toner specific concentration in the development member 13a is set to 7.50 wt % (initial value). The control unit 202 records the initial value of the toner specific concentration in the record unit 204. The control unit 202 outputs first sheet pixels from the LDs 21a to 21d of the exposure member 21 to the photoconductive drums 11a to 11d and calculates the print ratios of respective colors.

Here, the record unit 204 records a first toner specific concentration variation table prepared in correspondence to a variation amount of toner specific concentration whenever one sheet is printed with the print ratio shown in FIG. 5, for example. In the first toner specific concentration variation table shown in FIG. 5, the variation amount of the toner specific concentration corresponding to each print ratio is defined. In the first embodiment, the print ratio corresponds to the above-described low print ratio when the print ratio is in the range of 0% to 5%, in the range of 6% to 10%, and in the range of 11% to 20%. The toner specific concentration increases whenever one sheet is printed. The print ratio corresponds to the above-described high print ratio when the print ratio is in the range of 21% to 30%, in the range of 31% to 40%, in the range of 41% to 50%, in the range of 51% to 60%, in the range of 61% to 70%, in the range of 71% to 80%, and in the range of 81% to 100%. The toner specific concentration decreases whenever one sheet is printed. In this embodiment, change in the toner specific concentration of the Y toner will be described. The same is applied to the M, C, and K toner.

The control unit 202 acquires the variation amount of toner specific concentration on the basis of the print ratio of the Y toner calculated from the first toner specific concentration variation table recorded in the record unit 204. Then, the control unit 202 controls second sheet pixels to be output with a toner specific concentration (which is referred to as a target toner specific concentration) calculated by increasing or decreasing the variation amount of toner specific concentration in accordance with the print ratio from the toner specific concentration of 7.50 wt % (initial value) in output of the first sheet pixels. For example, when the print ratio of the Y toner is 10%, the target toner specific concentration in print of the second sheet is 7.5002 wt % obtained by adding 0.0002 wt % to 7.50 wt %. When the print ratio of the Y toner is 50%, the target toner specific concentration in print of the second sheet is 7.4997 wt % obtained by subtracting 0.0003 wt % from 7.50 wt %.

Subsequently, the control unit 202 controls third sheet pixels to be output with a target toner specific concentration calculated by increasing or decreasing the variation amount of toner specific concentration in accordance with the print ratio from the target toner specific concentration obtained upon outputting the second sheet pixels. For example, when the print ratio of the Y toner is 10%, the target toner specific concentration in print of a third sheet is 7.5004 wt % obtained by also adding 0.0002 wt % to the target toner specific concentration 7.5002 wt % in print of the second sheet. When the print ratio of the Y toner is 50%, the target toner specific concentration in print of the third sheet is 7.4994 wt % obtained by subtracting 0.0003 wt % from the target toner specific concentration 7.4997 wt % in print of the second sheet. When subsequent sheets of the fourth sheet are printed, the control unit 202 changes the target toner specific concentration in every print of one sheet in the same manner.

As a result, when an equal image is printed onto 1000 sheets, the target toner specific concentration in print of the second sheet is different from an initial value of the toner specific concentration in print of the second sheet. However, the image concentration can be uniformly maintained.

Subsequently, the control unit 202 supplies toner or discharges toner from the toner cartridge 40a to the development member 13a so as to reset the target toner specific concentration to the initial value of the toner specific concentration recorded in the record unit 204 before print of 1000 sheets ends and then the image quality maintenance is controlled. The control unit 202 controls the toner to be supplied from the toner cartridge 40a to the development member 13a, when the toner specific concentration is increased from the target toner specific concentration before the control of the image quality maintenance to the initial value. Conversely, the control unit 202 controls the toner to be discharged from the development member 13a, when the toner specific concentration is decreased from the target toner specific concentration before the control of the image quality maintenance to the initial value. Subsequently, the control unit 202 controls the image quality maintenance for the image forming unit 1, after the target toner specific concentration becomes the initial value.

Next, change in the toner specific concentration will be described according to a second embodiment.

First, the control unit 202 controls the image quality maintenance for the image forming unit 1, when the control unit 202 detects the image data to be printed and the number of print sheets input through the display unit 9 by a user. Then, the control unit 202 sets a predetermined initial value of the image concentration by changing a development bias value for the photoconductive drum 11a, a charging potential, and the intensity of a laser beam emitted from the exposure member 21. The control unit 202 stops the control of the image quality maintenance until the input number of print sheets are all printed or until print of the predetermined number of sheets (for example, 1000 sheets) ends.

Subsequently, the control unit 202 records in the record unit 204 the toner specific concentration in the development member 13a determined when the initial value of the image concentration is set. At this time, the toner specific concentration in the development member 13a is set to 7.50 wt % (initial value). The control unit 202 records the initial value of the toner specific concentration in the record unit 204. The control unit 202 outputs first sheet pixels from the LDs 21a to 21d of the exposure member 21 to the photoconductive drums 11a to 11d and calculates the print ratios of respective colors.

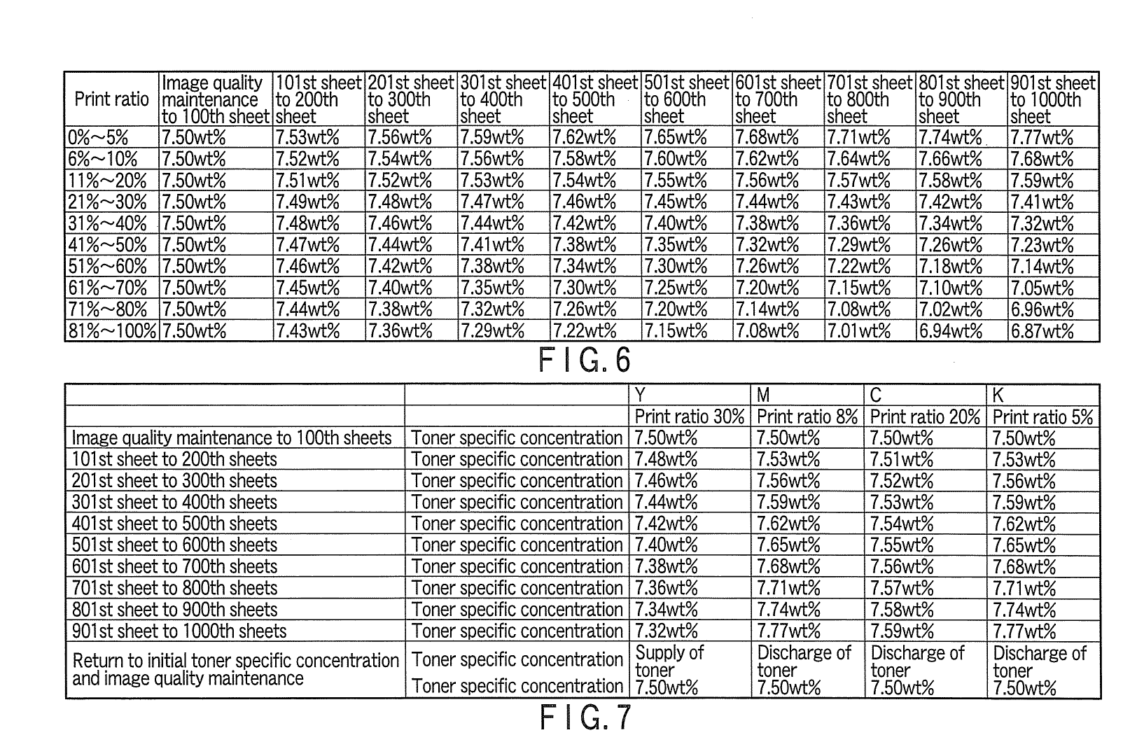

Here, the record unit 204 records a second toner specific concentration variation table prepared in correspondence to a variation amount of toner specific concentration in a unit of 100 sheets to be printed with the print ratio shown in FIG. 6. The print ratio is divided into the range of 0% to 5%, the range of 6% to 10%, the range of 11% to 20%, the range of 21% to 30%, the range of 31% to 40%, the range of 41% to 50%, the range of 51% to 60%, the range of 61% to 70%, the range of 71% to 80%, the range of 81% to 100%. Like the first embodiment, the print ratio corresponds to the low print ratio when the print ratio is in the range of 0% to 5%, in the range of 6% to 10%, and in the range of 11% to 20%. The print ratio corresponds to the high print ratio when the print ratio is in the range of 21% to 30%, in the range of 31% to 40%, in the range of 41% to 50%, in the range of 51% to 60%, in the range of 61% to 70%, in the range of 71% to 80%, and in the range of 81% to 100%. In addition, the number of print sheets is divided in a unit of 100 sheets in the range from the control of the image quality maintenance to a 1000th sheet, that is, the range of the control of the image quality maintenance to a 100th sheet, the range of a 101st sheet to 200th sheet, the range of a 201st sheet to a 300th sheet, . . . , the range of a 901st sheet to the 1000th sheet.

For example, when the print ratio is 10%, the target toner specific concentration in the range from the control of the image quality maintenance to the 100th sheet is defined as 7.50 wt % as an initial value. The target toner specific concentration in the range of the 101st sheet to the 200th sheet is defined as 7.52 wt %. As defined in the first toner specific concentration variation table shown in FIG. 5, the variation amount of toner specific concentration in every print of one sheet is +0.0002 wt % when the print ratio is 10%. Accordingly, the target toner specific concentration in print from the 101st sheet to the 200th sheet is 7.52 wt % obtained by adding a value of +0.0002 wt %×100 sheets, which is the variation amount of toner specific concentration for 100 sheets to be printed in the range from the control of the image quality maintenance to the 100th sheet, to the initial value 7.50 wt %. Likewise, the target toner specific concentration in the range of the 201st sheet to the 300th sheet is 7.54 wt % obtained by adding a value of +0.0002 wt %×100 sheets to the target toner specific concentration of 7.52 wt % in the range of the 101st sheet to the 200th sheet.

For example, the variation amount of toner specific concentration in every print of one sheet is −0.0003 wt % when the print ratio is 50%. Accordingly, the target toner specific concentration in print of the 101st sheet to the 200th sheet is 7.47 wt % obtained by subtracting a value of 0.0003 wt %×100 sheets, which is the variation amount of the toner specific concentration for 100 sheets in the range from the control of the image quality maintenance to the 100th sheet, from the initial value of 7.50 wt %. Likewise, the target toner specific concentration in print of the 201st sheet to the 300th sheet is 7.44 wt % obtained by subtracting a value of 0.0003 wt %×100 sheets, which is the variation amount of the toner specific concentration for 100 sheets in the range of the 101st sheet to the 200th sheet, from 7.47 wt % which is the target toner specific concentration in the print of the 201st sheet to the 300th sheet.

Here, calculation obtained by the control unit 202 when the print ratio of the Y toner is 30%, the print ratio of the M toner is 8%, the print ratio of the C toner is 20%, and the print ratio of the K toner is 5% will be described. FIG. 7 is a diagram illustrating a table prepared by obtaining the toner specific concentration in every print of the number of sheets from the second toner specific concentration variation table recorded in the record unit 204 in accordance with the print ratio of the Y, M, C, and K toner by the control unit 202.

The control unit 202 sets the target toner specific concentration of the Y, M, C, and K toner for a first sheet to the 100th sheet to 7.50 wt % which is the initial value in order to print the sheets. When an equal image is printed on 100 sheets, the control unit 202 changes the target toner specific concentrations into the unit of 100 sheets from a printer driver or an operation panel in which the number of print sheets is set through the display unit 9 by a user, in order to print the sheets. The control unit 202 changes the target toner specific concentrations of the Y, M, C, and K toner for the 101st sheet to the 200th sheet into 7.48 wt %, 7.53 wt %, 7.51 wt %, and 7.53 wt %, respectively.

In this way, the control unit 202 can uniformly maintain the image concentration, since it is possible to print the sheets in the unit of 100 sheets with the different toner specific concentration.

Subsequently, the control unit 202 supplies toner or discharges toner from the toner cartridges 40a, 40b, 40c, and 40d to the development members 13a, 13b, 13c, and 13d, respectively, so that the initial value of the toner specific concentration recorded in the record unit 204 becomes the target toner specific concentrations before print of the 1000th sheet ends or print of the designated number of sheets ends and then the image quality maintenance is controlled. Subsequently, the control unit 202 controls the image quality maintenance for the image forming unit 1, after the target toner specific concentrations become the initial values.

In the above description, the control unit 202 determines the target toner specific concentration in accordance with the print ratio and the number of print sheets from the second toner specific concentration variation table recorded in the record unit 204. The control unit 202 may calculate the second toner specific concentration variation table which defines the toner specific concentrations in the unit of 100 sheets shown in FIG. 6, from the first toner concentration variation table recorded in the record unit 204 when the toner specific concentration which is an initial value upon outputting the first sheet pixels is calculated.

In the above-described second embodiment, the toner specific concentration is changed in the unit of 100 sheets. However, the unit number of sheet may be changed.

In the above-described first and second embodiments, the image data of one page is printed on the plural sheets. However, image data of plural pages may be printed on plural sheets. For example, when one copy consists of three pages, the control unit 202 outputs pixels of a first-page from the LDs 21a to 21d of the exposure member 21 to the photoconductive drums 11a to 11d and calculates the print ratios of respective colors. Subsequently, the control unit 202 also calculates the print ratios of the respective colors for a second page and a third page. Then, the control unit 202 calculates an average of the print ratios for the respective colors of the three pages. As a result, the control unit 202 can acquire an average print ratio of the respective colors for one copy. In addition, the control unit 202 can control the target toner specific concentration for the subsequent copies of two copies on the basis of the acquired average print ratio.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a control unit which controls image quality maintenance;
a detection unit which detects a print command of image data;
a calculation unit which calculates a print ratio of the image data when the print command for printing at least a predetermined number of sheets is detected; and
a toner specific concentration control unit which sets toner specific concentration for each print of the plural sheets on the basis of the print ratio calculated by the calculation unit.

2. The apparatus of claim 1, wherein the toner specific concentration control unit sets the toner specific concentration in print of an (n+1)-th sheet differently from the toner specific concentration in print of an n-th sheet.

3. The apparatus of claim 2, wherein the toner specific concentration control unit changes the toner specific concentration by an increment or decrement value whenever one sheet is printed.

4. The apparatus of claim 3, further comprising a record unit which includes a first table in which the increment or decrement value is defined in accordance with the print ratio.

5. The apparatus of claim 1, wherein the toner specific concentration control unit sets the toner specific concentration for the predetermined number of sheets by the print command differently at an interval of a preset number of sheets.

6. The apparatus of claim 5, wherein the toner specific concentration control unit changes the toner specific concentration by the increment value or the decrement value whenever the preset number of sheets is printed.

7. The apparatus of claim 5, further comprising a record unit which includes a second table in which the toner specific concentration is defined at the interval of the preset number of sheets in accordance with the print ratio.

8. The apparatus of claim 1, wherein the control unit controls the image quality maintenance by changing a development contrast potential.

9. The apparatus of claim 1, wherein the control unit stops the control of the image quality maintenance when the print command for printing at least the predetermined number of sheets is detected.

10. The apparatus of claim 1, wherein the toner specific concentration control unit restores the toner specific concentration to an initial value after the print of the plural sheets and before the control of the image quality maintenance.

11. The apparatus of claim 1, wherein in the image data of plural pages, the calculation unit calculates a value obtained by adding the print ratios calculated for the plural pages and dividing the print ratios by the number of the plural pages as the print ratio.

12. An image forming method comprising:
controlling image quality maintenance;
detecting a print command of image data;
stopping the control of the image quality maintenance when the print command for printing at least a predetermined number of sheets is detected;
calculating a print ratio of the image data; and
setting toner specific concentration for each print of the plural sheets on the basis of the print ratio.

13. The method of claim 12, further comprising:
setting a value of the toner specific concentration in print of an (n+1)-th sheet differently from a value of the toner specific concentration in print of an n-th sheet.

14. The method of claim 13, further comprising:
changing the toner specific concentration by an increment or decrement value whenever one sheet is printed.

15. The method of claim 12, further comprising:
setting the toner specific concentration for the predetermined number of sheets by the print command differently at an interval of a preset number of sheets.

16. The method of claim 15, further comprising:
changing the toner specific concentration by the increment or decrement value whenever the preset number of sheets is printed.

17. The method of claim 12, further comprising:
controlling the image quality maintenance by changing a development contrast potential.

18. The method of claim 12, further comprising:
stopping the control of the image quality maintenance when the print command for printing at least the predetermined number of sheets is detected.

19. The method of claim 12, further comprising:
restoring the toner specific concentration to an initial value after print of the plural sheets and before control of the image quality maintenance.

20. The method of claim 12, further comprising:
calculating a value obtained by adding the print ratios calculated for plural pages and dividing the print ratios by the number of the plural pages as the print ratio, in the image data of plural pages.
